(19) United States
(12) Patent Application Publication
(10) Pub. No.: US 2009/0248525 A1
(43) Pub. Date: Oct. 1, 2009

(54) SPREAD ACTIVE MEDIA PLATFORM

(75) Inventor: Curtis Broome, Oakland, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EventMobile, Inc., Oakland, CA (US)

(21) Appl. No.: 12/419,497

(22) Filed: Apr. 7, 2009

Related U.S. Application Data
(63) Continuation-in-part of application No. 12/125,487, filed on May 22, 2008.
(60) Provisional application No. 60/940,347, filed on May 25, 2007.

(51) Int. Cl. G06Q 30/00; G06Q 50/00; G06F 17/30; G06F 17/40

(52) U.S. Cl. 705/14.4; 707/104.1; 707/E17.044; 707/E17.018

(57) ABSTRACT

Embodiments of the present invention provide a spread active media platform for distributing event-based information in a web-based communication environment. In one embodiment, a system and method for providing event-based services includes storing event information from a merchant, receiving event preference information from registered user. The event preference information may include customized user preferences, or the desired time, date, and/or location for a particular event. Next, the web-based application generates programming code associated with event preference information entered by the registered user. The registered user then transcribes the programming code into at least one electronic information source or device. Based upon a determined match between the transcribed programming code and the stored event information, event content relating to the event is published on the electronic information source or device.

### CROSS-REFERENCE TO RELATED APPLICATIONS

This application is a Continuation-in-Part of and claims priority from Nonprovisional U.S. patent application Ser. No. 12/125,487 filed May 22, 2008, which claims priority from and is a nonprovisional of U.S. Provisional Patent Application No. 60/940,347 filed May 22, 2008, entitled “SYSTEM AND METHOD FOR PROVIDING EVENT-BASED SERVICES,” the entire disclosure of which is hereby incorporated by reference, for all purposes, as if fully set forth herein.

### FIELD OF THE INVENTION

The present invention relates generally to the field of information distribution, and more particularly, to a system and method for distributing event-based information in a web-based communication environment.

### BACKGROUND OF THE INVENTION

With the use of the Internet becoming commonplace, there is now an overwhelming demand for the most current news and information. The latest headlines, weather, and traffic reports are just a few of the many types of information that online users demand. In addition, merchants are able to utilize the Internet to post new sales and promotional events. However, merchants are only able to reach customers when they visit the merchant's website, receive emails, or by paying for expensive advertisements on more popular websites, more popular mobile websites or applications, or more popular mobile internet devices.

Wireless devices, particularly cellular phones, have become ubiquitous in today's society and provide yet another platform for people to obtain live information. Today's wireless devices can access the Internet at a touch of a button, providing users with instantaneous access to any desired information, including downloadable content such as streaming video and audio files. However, users are typically able to receive this desired information and content by performing a search through a search engine, or by visiting a desired website already known to the user. Moreover, merchants are still limited in how they can communicate with a target consumer in order to deliver the latest sales and promotional news.

Therefore, there is a need to provide merchants and users alike with a system and method for accessing, publishing, and sharing news, multimedia content, and the like without requiring a user query for the desired information.

### BRIEF SUMMARY OF THE INVENTION

Embodiments of the present invention provide a system and method for distributing event-based information in a web-based communication environment.

In an exemplary embodiment, the method for providing event-based services includes storing event information into a database, and inputting event preference information by a registered user into a web-based application. The event preference information may include customized user preferences or the time, date, and location for a particular event. Next, the web-based application generates programming code that is associated with event preference information input by the registered user. The registered user then transcribes the programming code into a electronic information source or device such as a merchant website or mobile device. If their a match between the stored event information and at least one of the preference set, the event time, the event date, or the event location associated with the transcribed programming code, event content relating to the event is then published on the electronic information source or device.

Another embodiment of the present invention includes receiving updated event information via the web-based application. When a match is determined between the updated event information and the event preference information, the published event content is dynamically updated on the electronic information source or device.

### BRIEF DESCRIPTION OF THE DRAWINGS

FIG. 1A is a block diagram illustrating aspects of an exemplary operating environment according to an embodiment of the present invention, and FIG. 1B is a simplified block diagram illustrating the same.

FIG. 2 is a flowchart illustrating the Spread Active Media Platform according to an embodiment of the present invention.

### DETAILED DESCRIPTION OF THE INVENTION

A system and method for distributing event-information is disclosed. The following description is provided to enable any person skilled in the art to make and use the invention and sets forth the best modes contemplated by the inventor for carrying out the invention. Various modifications will remain readily apparent to those skilled in the art. Any and all such modifications, equivalents and alternatives are intended to fall within the spirit and scope of the present invention.

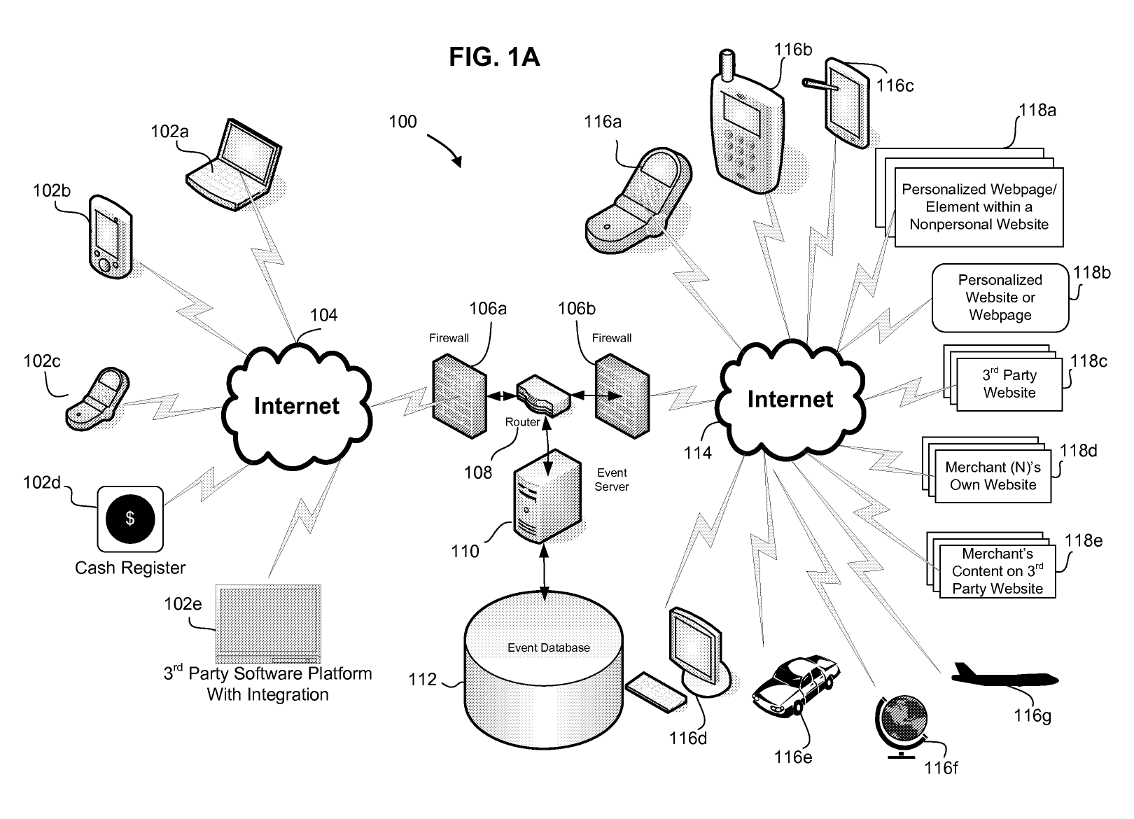

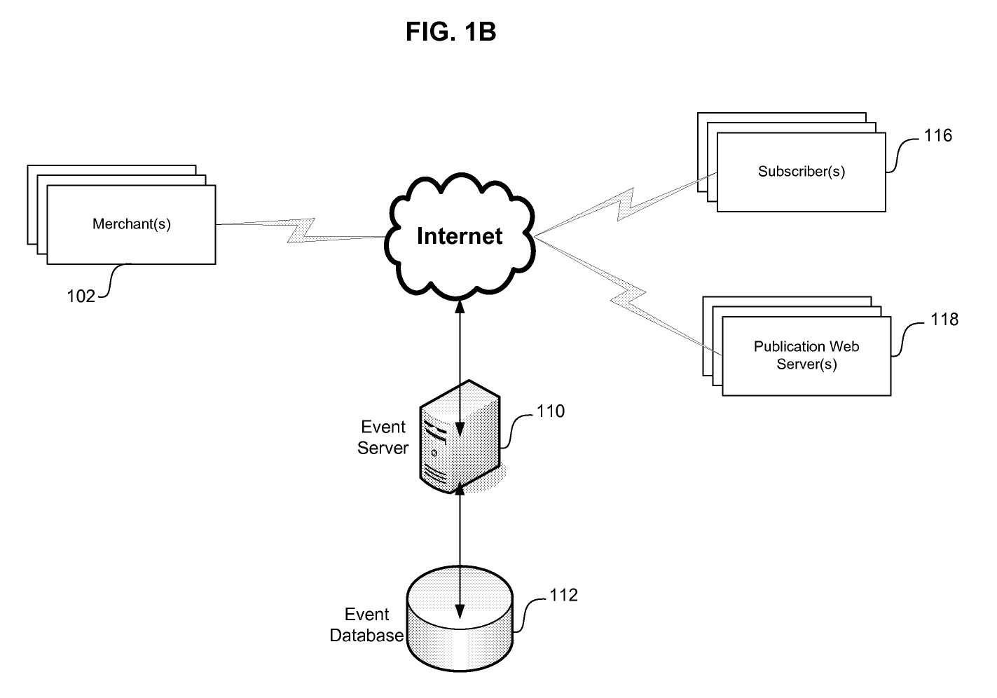

FIG. 1A provides an overall view of the preferred communication system, and FIG. 1B is a simplified view according to embodiments of the present invention. As shown in FIG. 1A, communication system 100 includes a plurality of merchant systems/devices (“merchants”) 102a, 102b, 102c, 102d, and 102e, an event server 110, an event database 112, a plurality of subscriber systems/devices (“subscribers”) 116a, 116b, 116c, 116d, 116e, 116f, and 116g and a plurality of website and web pages 118a, 118b, 118c, 118d, and 118e.

An Event Service Provider (“ESP”) runs on the event server 110, which is connected to network 104 and 114. Firewalls 106a and 106b, and router 108 may be utilized for additional security for the event server 110. An event database 112 is associated with event server 110 and is responsible for storing information relating to the merchants, ticket providers, performing artists, merchant aggregators, and subscribers. For example, the event database 112 stores a merchant profile of each merchant who registers with the ESP. A more detailed description of the merchant profile is provided below. The ESP supplies a web interface for interactions among the merchants and subscribers. Embodiments of the present invention are usable with a number of networks, such as the global internetwork of networks referred to as the “Internet” and its variants (e.g., intranets, virtual nets, overlay networks and the like).

The merchants 102a, 102b, 102c, 102d, and 102e may be any vendor offering goods and services across the Internet or other networks_including ticket providers, performing artists, and merchant aggregators. Additionally, merchants 102a, 102b, 102c, 102d, and 102e may also be any entity interested in providing information to a user, such as a ticket or real estate broker, individuals, or school administrators. Merchants register with the ESP by filling out a merchant profile via the ESP web interface. The merchant profile includes detailed information about the merchant such as name, contact information, and address. Furthermore, merchants 102a, 102b, 102c, 102d, and 102e then send to the event server 110 through network 104, and the ESP web interface, the merchant profile and event information relating to an upcoming event. The event information may include the time, date, or location of the event, venue, category and/or publication duration.

Subscribers subscribe with the ESP via the network 114 and the ESP web interface. A subscriber can be any electronic device configured to connect to the network. For example, subscriber 116a is a mobile phone device with a third party client, subscriber 116b is a personal cell phone or smart phone with a native client, and subscriber 116c is a personalized wireless device with a native or third party client, subscriber 116d is a personal computer, subscriber 116e is a computer or subscriber device on board an automobile, subscriber 116f is a global positioning system or mapping service, and subscriber 116g is a computer or subscriber device on board an aircraft. Additionally, the subscriber device may be equipped with a global positioning system (GPS) receiver for relaying positional information to the event server.

The event server 110 saves information related to each subscriber in the event database 112. For example, subscriber information may include an Internet client ID, a wireless device ID, and event preferences. In addition, a subscriber might specify a number of event preferences for various entertainment, lifestyle, and business categories. For example, event preferences may include desired music artists, sports teams, restaurants, and the like. The event preferences associated with each subscriber are important in determining which event-based service each particular subscriber would like receive.

Additionally, merchants and users can use the ESP to share event information from a wide range of devices with internet access to a wide range of other devices with internet access. For example, event sharing can be accomplished using internet access devices (IAD), internet access services (IAS) such as mapping or music services, or via internet accessing vehicles (transportation services) such as automobiles, trucks, sport utility vehicles, or airplanes.

Event information sharing offers a number of different scenarios including merchant to user, merchant to a targeted group, merchant to preferential or untargeted group, user to user, user to familiar group, user to unknown user, or user to known group (public sharing). The ESP web interface is also configured to allow users to maintain a personalized address book of users for quick reference. However, the spirit and intent of event information sharing can be maintained through other scenarios, formats, device, or services not listed here.

### Spread Active Media Platform

The Spread Active Media platform (hereinafter “Spread Platform”) is a platform and internet-based service provided by the ESP which enables registered users to easily create and publish custom event services. As shown in FIG. 1B, examples of registered users and services include merchants 102, publication web servers 118 including publishers of applications for mobile devices, mobile services, websites, blogs, and other information services, and subscribers 116. That is, as will be described in detail below, the Spread Platform allows a register user to offer customized event services based on the user preferences, or the time, date, and location of a particular event. The Spread Platform may also include the ability for publishers to offer the goods and services of the merchants such as ticketing, real estate listings, or merchandising. In addition, consumers may utilize the Spread Platform as a service that enables personalized event services from their mobile devices to personal websites, social networks, and websites with personal services, and to other mobile devices of registered users and non-users.

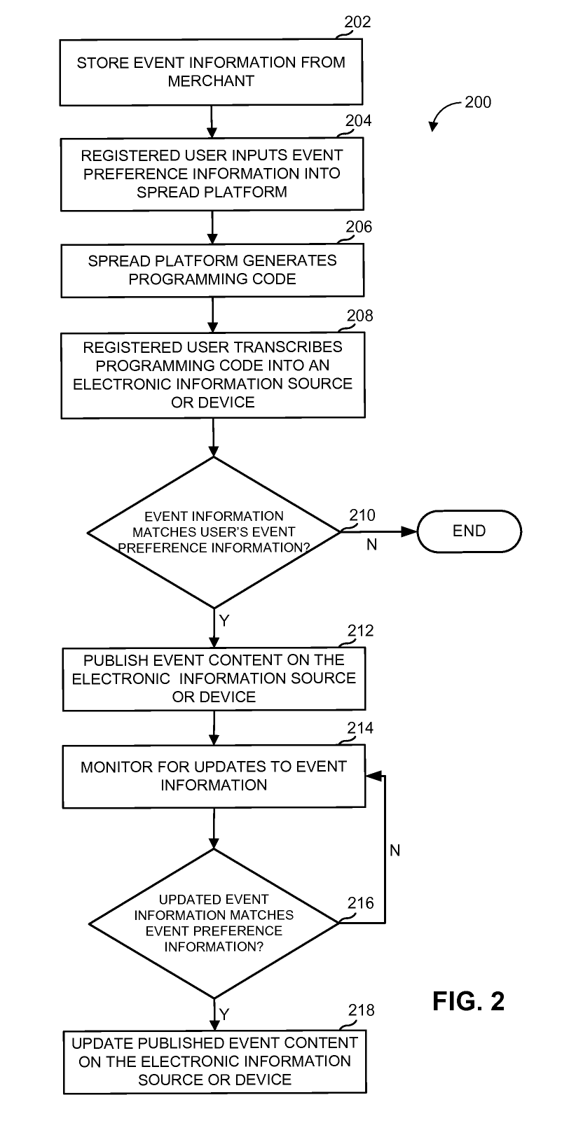

Referring now to FIG. 2, a flow diagram illustrating the preferred steps in accordance with one embodiment of the present invention is shown. In step 202, merchant information regarding a particular event provided by the merchant is stored in the event database. In step 204, a registered user inputs event information into the Spread Platform. Typically, the event preference information may include the time, date, or location of a particular event. The event preference information may also include customized preferences set by the registered user for various types of event content the user desires to receive. Following step 204, in step 206, the Spread Platform generates programming code associated with the event information entered by the registered user. Examples of the generated programming code include HTML, XHTML, JavaScript, CSS, XML, or the like.

In step 208, the registered user copies and pastes the generated programming code into the electronic information source or device. For example, the programming code concerning the event information may be copied into a website, blog, application, mobile device, or any internet service that enables the registered user to concurrently publish particular goods or services in real time. Of course, the programming code may be transcribed into a multiple electronic information sources or devices.

Furthermore, in step 210, ESP looks for a match between the event information stored in the database and at least one of the preference set, the event time, the event date, or the event location associated with the transcribed programming code. The event information may match up with two, three, or even all four items of the event preference information, but must match with at least one item of the user's event preference information. Once a match is determined, in step 212 event content related to the particular event is then published to the electronic information source or device. More particularly, the event content is published based on the user preferences, event time, event date, or event location represented by the generated programming language residing on the primary electronic information source or device.

In step 214, the Spread Platform monitors for updates to the event information. Once an update is determined (e.g. discounted ticket prices), the updated information is matched with the event preference information entered by the registered user in step 216. If a match is determined, then in step 218 the published event content on the electronic information source or device is dynamically updated to compliment the updated event information.

Furthermore, the publishing aspects of the Spread Platform may also be utilized by third-party publishers of software applications for mobile devices, mobile services, websites, blogs, or any other medium with internet access. Once a third party publisher registers with the ESP, the publisher is given programming code to simply copy and paste into their software application, mobile service, website, blog, or other published medium according to the specified publisher preferences, time, date, and/or location. The publisher is then enabled as a distributor and seller of the goods and services on the ESP network and may combine the merchant services offered through ESP with any proprietary or third-party editorial content, publishing system, or software application.

For example, the online San Jose Mercury News Publication (Sports Section, www.mercurynews.com/sports) could register with the Spread Platform in order to receive event and ticket information relating to the San Jose Sharks. Once registered, the publisher could then enter event preference information such as weekday games for date, night games for time, home games for location, or other event preference information. The Spread Platform would then generate programming code associated with the entered event preference information. Accordingly, when event information concerning the Sharks is published with the ESP, the Spread Platform determines if there is a match between the published event information and the event preference information. If so, event content relating to event information is then published on the publisher's website. In the present example, if the event information concerned discount ticket sales for the Sharks' Tuesday home game, that information/content would then be published on www.mercurynews.com/sports. The event content could also be published to multiple website and mobile devices. As such, goods or services can be published concurrently to the merchant's website(s), proprietary pages on third-party websites, proprietary applications, or to third-party mobile devices or services.

Consumers may also use the Spread Platform to publish text, photos, audio, video, or other multimedia to the ESP network, to their personal groups, to third-party websites and applications which are part of the ESP network, and to personal pages on social networks. Like merchants, consumers are given programming code generated by the Spread Platform which the user simply copies and pastes into any website, blog, application, device, Internet service, or social network, enabling the consumer to publish multimedia in real time.

The event content, event information, goods, and services available for distribution using the Spread Platform may be aggregated using a variety of technologies. For example, information aggregation can be accomplished via internet crawling, indexing, and/or search. Further examples include, but are not limited to, merchant input, supplier input, third-party aggregator input, user-based input, third-party based input, or even ESP editorial input.

Additionally, the Spread Platform can facilitate communication between a given merchant and a consumer, a merchant and an audience (or group), a consumer and another consumer, a consumer and a group, or a consumer and their personal pages on third-party websites, web services, social networks, and personalized mobile applications and devices. An example of communication services that are utilized by the Spread Platform include, but are not limited to, dynamic texting, email, text messaging, instant messaging, RSS, video, and VOIP. All of these communication services may be distributed and enabled for publishers using the Spread Platform. The embodiments of the present invention enable direct customer communication and consumer word of mouth communication service offerings for merchants, publishers, and consumers who use the Spread Platform.

### Fulfillment Systems

Real-time demand generation is a key benefit of the ESP and the Spread Platform, and accordingly, fulfillment of this demand is another key benefit thereof. Merchants and other registered users may fulfill demand through targeted distribution of good and services such as tickets, reservations, merchandise, and any other similar event response.

For instance, registered users may use the ESP to offer their own ticketing service, a third party ticketing service who may be a supplier, or ticket using a proprietary ESP ticketing service. Registered users may also buy or sell 3^{rd} party and proprietary tickets on the ESP web-based interface. Merchants who register and use the ESP have the option of offering their own door/entry management system, a third-party door/entry management system, or ESP's proprietary door/entry management system. As another example, registered users may use ESP services to offer their own seating/table reservation system, a third-party seating/table reservation system, or ESP's proprietary seating/table reservation system. Still further, registered merchants may use ESP services to offer their own merchandising system, a third-party merchandising system, or ESP's proprietary merchandising system.

It will be recognized by persons of ordinary skill in the art that the method of the invention has many applications, and that this description has not attempted to enumerate all possible variations. For example, functionality exists such that users can receive and share live broadcast or simulcasts including video, audio, text, or any combination thereof, and merchants can also broadcast live events based on time, date, and location. In addition, users may also submit event information, enabling them to share and invite other users to their own event. The ESP web interface also includes functionality to allow users to input, share, and publish reviews of a given event, or any experiential aspect of the event (i.e. venue, food, service, etc.). The scope and spirit of the invention also extends to various combinations and modifications that may fall within the spirit of the appended claims.

What is claimed is:

1. A method for distributing event information in a web-based communication system that includes a web-based application, a merchant system used by a merchant, and a electronic information source or device used by a registered user, the method comprising:
storing, in a database, event information associated with an event provided by the merchant system;
receiving, in the web-based application used by the registered user, event preference information including a preference set, event time, event date, and event location;
generating, via the web-based application, programming code associated with the event preference information;
transcribing, via the registered user, the programming code into the electronic information source or device; and
publishing event content on the electronic information source or device based on a match between the stored event information and at least one of the preference set, the event time, the event date, or the event location associated with the transcribed programming code.

2. The method of claim 1, further comprising:
receiving updated event information from the merchant and the web-based interface;
updating, dynamically, the published event content on the electronic information source or device based on a match between the updated event information and at least one of the preference set, the event time, the event date, or the event location associated with the transcribed programming code.

3. The method of claim 1, wherein the merchant is any vendor offering goods or services, a performing artist, a ticket provider, a merchant aggregator, a publisher, or a user.

4. The method of claim 3, wherein the registered user is a merchant offering goods or services, a publisher that offers the goods or services of the merchant, or a consumer.

5. The method of claim 1, wherein the electronic information source or device includes a website, software application, blog, or mobile device.

6. The method of claim 1, wherein the programming code is transcribed into a plurality of electronic information sources or devices.

7. The method of claim 6, wherein the event content is published to the plurality of electronic information sources or devices.

8. The method of claim 1, wherein the preference set includes preferences customized by a merchant or a user.

9. The method of claim 1, wherein the published event content is dynamically updated on the electronic information source or device based on the event time and the event date.

10. The method of claim 1, wherein the published event content is dynamically updated on the electronic information source or device based on the event time, the event date, and the event location.

11. A system for distributing event information in a web-based communication environment, the system comprising:
a database for storing event information associated with an event provided by a merchant;
a web-based interface for receiving event preference information from a registered user, the event preference information including an event time, event date, and event location;
a code generation module for generating programming code associated with the event preference information input by the registered user; and
an electronic information source or device associated the registered user for transcribing the programming code;
wherein event content is published to the electronic information source or device based on a match between the stored event information and at least one of the preference set, the event time, the event date, or the event location associated with the transcribed programming code.

12. The system of claim 11, further comprising:
wherein the web-based interface receives updated event information from the merchant corresponding to the event; and
wherein the published event content is dynamically updated on the electronic information source or device based on a match between the updated event information and at least one of the preference set, the event time, the event date, or the event location associated with the transcribed programming code.

13. The method of claim 11, wherein the merchant is any vendor offering goods or services, a performing artist, a ticket provider, a merchant aggregator, a publisher, or a user.

14. The system of claim 13, wherein the registered user is a merchant that sells goods and services, a publisher that offers the goods or services of the merchant, or a consumer.

15. The system of claim 11, wherein the electronic information source or device includes a website, software application, blog, or mobile device.

16. The system of claim 11, wherein the programming code is transcribed into a plurality of electronic information sources or devices.

17. The system of claim 16, wherein the event information is published to the plurality of electronic information sources or devices.

18. The system of claim 11, wherein the preference set includes preferences customized by a merchant or a user.

19. The method of claim 11, wherein the published event content is dynamically updated on the electronic information source or device based on the event time and the event date.

20. The method of claim 11, wherein the published event content is dynamically updated on the electronic information source or device based on the event time, the event date, and the event location.
